(19) United States
(12) Patent Application Publication
(10) Pub. No.: US 2019/0287167 A1
(43) Pub. Date: Sep. 19, 2019

(54) SYSTEM FOR CONFIGURING SUBSETS IN A JAPANESE REVERSE AUCTION

(71) Applicant: Zycus Infotech Pvt. Ltd., Mumbai (IN)

(72) Inventors: KANISHKA GHOSH, Mumbai (IN); CHIRANJEEV SETHI, Mumbai (IN)

(73) Assignee: Zycus Infotech Pvt. Ltd., Mumbai (IN)

(21) Appl. No.: 16/172,054

(22) Filed: Oct. 26, 2018

(30) Foreign Application Priority Data
Mar. 13, 2018 (IN) 201821009130

(51) Int. Cl. G06Q 30/08

(52) U.S. Cl. CPC G06Q 30/08

(57) ABSTRACT

A system is described for configuring subsets in a Japanese reverse auction. The advantage of the system is that the bidding on a particular auction item does not necessarily have to end, even when there are no bidders at that price. The system provides for a solution that allows the auction to continue by creating subsets on the original auction item or on the price of the original auction item.

### CROSS-REFERENCE TO RELATED APPLICATION

The instant application claims priority to Indian Patent Application Serial No. 20181009130, filed Mar. 13, 2018, pending, the entire specification of which is expressly incorporated herein by reference.

### FIELD OF INVENTION

The present invention relates to a system for configuring subsets in a Japanese reverse auction.

### BACKGROUND OF THE INVENTION

In a Japanese reverse auction, the host of the auction (the buyer/user) states an opening price and participants (sellers) have to accept that price level or withdraw from the auction. Acceptance indicates that the participant is prepared to supply at the stated price. If there are multiple participants still taking part in the auction, then the price of the item decreases automatically after a specific period of time. The value of the decrement is decided by the host, and can vary from one step to the next. If a participant wishes to remain a part of the auction, he/she must put in a bid at each price change step. If a participant does not put in a bid, he/she will be withdrawn from the auction for that particular item.

In the current scenario, if there are no takers for the item at a particular price, the auction is closed. The present invention provides for a method of continuing the auction, by modifying parameters (such as number of goods or price of goods) to keep the reverse auction going.

### PRIOR ART

U.S. Patent Application Publication No. 20020111907 relates to a method for conducting electronic commerce transactions between a user and a plurality of vendors offering tangible goods, content, or services for rental or sale at a plurality of vendor web sites.

U.S. Patent Application Publication No. 20020026400 relates to a method and an associated system providing for the trading of commodities such as financial instruments in an auction or reverse auction format.

U.S. Pat. No. 7,130,815 discloses a system of performing reserve price reverse auctions is disclosed. In one embodiment, the reverse auction immediately ends if an offer below the reserve price is received. In another embodiment, the reverse auction continues until the buyer accepts an offer such that transaction with the accepted offer is consummated or a time period expires. If the time period expires and no offer is below the reserve price, then the user select from the received offers. If there is at least one offer below the reserve price and at least one other offer, then the system presents the user with the received offers and gives the user a time period to select one. If the user selects an offer, a transaction with the select offer is consummated. If no offer is selected, then a transaction with the lowest received offer is consummated.

U.S. Patent Application Publication No. 20020147674 describes an electronic buying system and method that dynamically matches, over the World Wide Web, a person or business entity requesting a specialized product with a person or entity capable of providing that product. The electronic buy system, which may function as a reverse auction, is utilized from personalized home pages for both buyers and suppliers.

U.S. Patent Application Publication No. 20040083156 discusses systems and techniques to create and conduct a reverse auction include creating a reverse auction object having a number of components; and copying information from a number of components in a Request for Quotation (RFQ) object into corresponding components of the reverse auction object. Bids received for the RFQ may be copied into the reverse auction object, and information in the bids may be validated. If the bids do not include information required for the reverse auction object, the bid may be marked as incomplete.

None of the aforementioned prior art touches upon the two main disadvantages of a Japanese reverse auction (namely, that the buyer loses out on potential sellers and sellers who withdrew from the auction in the first round lose out on a chance to bid for the item in the second round). The invention described herein overcomes these disadvantages through a system of configuring Japanese reverse auctions.

### OBJECTIVES OF THE INVENTION

A primary object of the present invention is to provide a system for configuring subsets in a Japanese reverse auction.

A further object of the present invention is to provide a method to keep an auction running even when there are no bidders for the item at a particular price.

### SUMMARY OF THE INVENTION

Before the present invention is described, it is to be understood that the present invention is not limited to particular methodologies and materials described, as these may vary as per the person skilled in the art. It is also to be understood that the terminology used in the description is for the purpose of describing the particular embodiments only, and is not intended to limit the scope of the present invention.

The present invention describes a system for configuring subsets in a Japanese reverse auction. The advantage of the present invention is that the bidding on a particular auction item does not necessarily have to end, even when there are no bidders at that price. The system described herein provides for a solution that allows the auction to continue by creating subsets on the original auction item or on the price of the original auction item.

### DETAILED DESCRIPTION OF THE INVENTION

Before the present invention is described, it is to be understood that this invention is not limited to particular methodologies described, as these may vary as per the person skilled in the art. It is also to be understood that the terminology used in the description is for the purpose of describing the particular embodiments only, and is not intended to limit the scope of the present invention. Throughout this specification, the word “comprise”, or variations such as “comprises” or “comprising”, will be understood to imply the inclusion of a stated element, integer or step, or group of elements, integers or steps, but not the exclusion of any other element, integer or step, or group of elements, integers or steps. The use of the expression “at least” or “at least one” suggests the use of one or more elements or ingredients or quantities, as the use may be in the embodiment of the invention to achieve one or more of the desired objects or results.

A Japanese reverse auction is a type of auction in which the price of the item decreases automatically after a fixed time interval. The value by which the price change occurs is defined by the buyer in different steps. The buyer can define multiple steps with different decremental values for the price change. In this auction, if the seller wants to continue in the auction process, they must submit the bid at each price change step. If a seller does not bid for the item, the seller is withdrawn from the auction of that item. The seller can however, bid for another item. The auction remains open until no seller is remaining to bid or the price falls to the minimum possible value.

From the preceding paragraph, it can be understood that if there are no bidders for an item at a particular price, the item is taken off the auction and bidding for the next auction item is opened. The item for which the auction was prematurely ended may be brought back into the auction at a later time, wherein the bidding will carry forth from the last price (i.e., the price on which the auction was terminated due to lack of bidders). Further, the bidders who withdrew from the auction of this item in the first round cannot bid for it again.

Thus in the present system, the buyer loses out on potential sellers, and sellers who withdrew from the auction in the first round lose out on a chance to bid for the item in the second round.

The present invention describes a system that overcomes the two-fold drawbacks discussed in the preceding paragraph. The system allows for the bidding on the particular item to continue by creating a “subset” of that item. Further, even those sellers who withdrew from the auction for the item can continue to bid for the subsets of the item. The system is configurable such that the buyer can decide how the subset is to be created. The intelligent engine of the system suggests possible subset configurations to the buyer for confirmation before creating the subset chosen by the buyer. This aforementioned engine designs the subsets based on a parameters determined based on various decision rules (which include supplier performance scores which are available to the buyer, supplier performance during the auction, market data for the commodity being auctioned and a pattern of how suppliers have performed in their previous bids). The information for the decision rules discussed in the previous sentence is obtained through the integration of the e-auction module described herein with a supplier performance software module. The supplier performance module has a feature to generate supplier performance score based on the inputs provided into the module such as delivery time, quality, after sales service, etc. The supplier performance score is fetched by the e-auction module in order to help generate the appropriate subsets.

The embodiments of the aforementioned system are described in these paragraphs. The system is configured to create subsets based on permutations and combinations of statistics of how the bidders have performed in the initial auction for the item, the market data on the best possible price for the item, who the suppliers are, etc. A subset can be either of the following:

Increase in the start price as compared to the earlier price, with a steeper decrement amount offered in each step as compared to the earlier decrement amount.

Reduction in the number of goods offered as compared to the earlier number.

The system will continue to make such subsets until it gets a taker for the price offered. Then the system will run another auction including only the winners of each subset, wherein the final bidder is the winner of the entire item. The process of making subsets is illustrated through the following examples:

Making subsets by price:

The following table describes three steps in a Japanese auction between 6 suppliers (S1, S2, S3, S4, S5 and S6).

| | S1 | S2 | S3 | S4 | S5 | S6 |
|---|---|---|---|---|---|---|
| 50 (Step 1) | Yes | Yes | Yes | Yes | Yes | Yes |
| 45 (Step 2) | No | No | Yes | Yes | Yes | Yes |
| 40 (Step 3) | No | No | No | No | No | No |

From the above table, it can be gleaned that all six suppliers are willing to provide the item at a cost of 50, and hence the auction moves to Step 2 (wherein the item cost decrements to 45). At this step, suppliers 1 and 2 drop out of the auction. Remaining in the auction are S3, S4, S5 and S6. The auction proceeds to Step 3, wherein the cost of the item after the decrement is 40. At this step, all the suppliers drop out of the auction. In other words, none of the suppliers are willing and/or able to supply the item at a cost of 40.

At this step, the system described herein uses the information detailed in the preceding paragraph to devise a subset of the above item so that the suppliers who dropped out at the last step may continue bidding on the item (if they so wish). The next table describes the situation of the subset, in which 3 out of the 4 remaining suppliers have chosen to continue in the bidding (i.e., S3, S4 and S6):

| | S3 | S4 | S6 |
|---|---|---|---|
| 48 (Step 1) | Yes | Yes | Yes |
| 47 (Step 2) | Yes | Yes | Yes |
| 44 (Step 3) | No | No | No |

From this subset, it is seen that suppliers 3, 4 and 6 are not willing and/or able to supply the item at a price of 44. Based on this new information, the system once again creates a subset and which all or any of these three suppliers may take part. This subset is described in the following table:

| | S3 | S4 |
|---|---|---|
| 44 (Step 1) | Yes | Yes |
| 43 (Step 2) | Yes | Yes |
| 42 (Step 3) | Yes | No |

Now, there is only one final supplier left, who is willing to provide the item at the lowest achieved price of 42. Thus, S2 is the winner of this Japanese auction.

Making subsets by number of items:

The following table describes three steps in a Japanese auction between 6 suppliers (S1, S2, S3, S4, S5 and S6):

| Price | Quantity | S1 | S2 | S3 | S4 | S5 | S6 |
|---|---|---|---|---|---|---|---|
| 50 | 50 | Yes | Yes | Yes | Yes | Yes | Yes |
| 45 | 50 | No | No | Yes | Yes | Yes | Yes |
| 40 | 50 | No | No | No | No | No | No |

Since none of the suppliers are willing to deliver the item at a price of 40 for a quantity of 50 units, the system will split the above auction into two auctions by dividing the number of units between the two auctions. These two auctions are as follows:

Subset 1:

| Price | Quantity | S3 | S4 |
|---|---|---|---|
| 28 | 20 | Yes | Yes |
| 27 | 20 | Yes | Yes |
| 24 | 20 | No | No |

Subset 2:

| Price | Quantity | S3 | S4 | S6 |
|---|---|---|---|---|
| 38 | 30 | Yes | Yes | Yes |
| 37 | 30 | Yes | Yes | Yes |
| 34 | 30 | No | No | No |

The process of creating multiple subsets of each auction will continue until one final supplier, at the lowest price for that number of units, is left. Once the final supplier for each subset has been identified, the system will create a final auction between all the subset auction winners to determine the winner of the complete 50 units.

The present invention overcomes the limitations that are imposed in the traditional form of the Japanese auction that is currently in use. These limitations being that in the present system:

the buyer loses out on potential sellers, and

sellers who withdrew from the auction in the first round lose out on a chance to bid for the item in the second round.

When the auction is carried out as per the model described herein, both these disadvantages are overcome, resulting in a profit to both the buyer and the sellers.

What is claimed is:

1. A system for configuring subsets in a Japanese reverse auction, wherein the subsets are created based on permutations and combinations of statistics of how the bidders have performed in the initial auction for the item, the market data on the best possible price for the item, who the suppliers are, amongst other related factors.

2. The system for configuring subsets as claimed in claim 1, wherein the system is configurable such that the buyer can decide how the subset is to be created.

3. The system for configuring subsets as claimed in claim 1, wherein the system suggests possible subset configurations to the buyer for confirmation before creating the subset chosen by the buyer.

4. The system for configuring subsets as claimed in claim 1, wherein the subsets may be made by increasing the start price as compared to the earlier price, with a steeper decrement amount offered in each step as compared to the earlier decrement amount, or reducing the number of goods offered as compared to the earlier number.

5. The system for configuring subsets as claimed in claim 1, wherein the system continues to make subsets until it gets a taker for the price offered.

6. The system for configuring subsets as claimed in claim 1, wherein the system runs a final auction including only the winners of the auction subsets, such that the winner of this final auction is the winner of the entire item.
